(19) United States
(12) Patent Application Publication
(10) Pub. No.: US 2005/0177475 A1
(43) Pub. Date: Aug. 11, 2005

(54) Method for accessing an account in an account management device

(75) Inventors: Manfred Lilge, Berlin (DE); Thomas Ryll, Wolfsburg (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/008,645

(22) Filed: Dec. 10, 2004

(30) Foreign Application Priority Data
Dec. 12, 2003 (DE) 103 59 827.8

(51) Int. Cl. G06F 17/60

(52) U.S. Cl. 705/30

(57) ABSTRACT

The invention relates to a method for accessing an account in an account manager device, where the method involves the following method taking place when a billing request arises which relates to a first sum value in the account. An access device reads a second sum value, which is buffer-stored in a buffer store associated with the account, from the buffer store, the first sum value and the second sum value are added to form a total value, the total value is compared with a predetermined threshold value, an access message relating to the account is sent to the account management device if the threshold value is exceeded, or the total value is buffer-stored in the buffer store and the access is terminated if the threshold value is undershot.

### CLAIM FOR PRIORITY

This application claims the benefit of priority to German Application No. 103 59 827.8, which was filed in the German language on Dec. 12, 2003, the contents of which are hereby incorporated by reference.

### TECHNICAL FIELD OF THE INVENTION

The invention relates to a method for accessing an account in an account management device.

### BACKGROUND OF THE INVENTION

In today's fast-living commercial and industrial world, customers are being offered a large number of products for purchase and a large number of services for use. To bill for such purchases and provided services, account management devices have been installed—for example in second or third generation mobile radio networks—which electronically manage accounts for the purchasers and service users. To be able to react as quickly as possible to access to the accounts or to access to account balance information using such account management devices when purchase transactions arise or services are used, and to allow short response times from the account management devices, a high level of technical complexity needs to be pursued, which includes the installation of powerful hardware and software components.

### SUMMARY OF THE INVENTION

The invention discloses a method which can be used to access an account in an account management device with little complexity and inexpensively.

In one embodiment of the invention, there is a method for accessing an account in an account management device, where the method involves taking place when a billing request arises which relates to a first sum value in the account:
an access device reads a second sum value, which is buffer-stored in a buffer store associated with the account, from the buffer store,
the first sum value and the second sum value are added to form a total value,
the total value is compared with a predetermined threshold value,
an access message relating to the account is sent to the account management device if the threshold value is exceeded, or
the total value is buffer-stored in the buffer store and the access is terminated if the threshold value is undershot.

One advantage of this method is that the access message relating to the account is sent to the account management device if the threshold value is exceeded. This will be the case, for example, when the billing request relates to a relatively large sum value, that is to say when a large sum value (of money) needs to be debited from the account, for example. However, if the billing request relates to a small sum value (for example because a service with a very low monetary value is being provided or a very low-value product is being purchased) and if the buffer store additionally stores a small second sum value, then no access message is sent to the account management device, but rather the total value is buffer-stored in the buffer store and is taken into account in the next method cycle. This significantly lowers the complexity for accessing the account or for accessing account balance information, since not every billing request (e.g. every debit request which relates to the account) results in the access message being sent to the account management device. For this reason, by way of example, the account management device requires hardware and/or software components which have relatively low power as compared with a method in which every billing request involves an access message being sent to the account management device. This allows the account management device to be implemented less expensively.

In another embodiment of the invention, the method may proceed in a manner such that the access message prompts the account management device to reduce the account balance in the account by a total sum value which corresponds to the total value and, upon successful reduction, to send an access confirmation message to the access device. In this context, the access message advantageously prompts the total sum value (for example a currency sum) which corresponds to the total value to be debited from the account and prompts the access confirmation message to be used to send information about the successful debit to the access device. In a similar fashion to the advantage explained above, this involves fewer access operations which alter the account balance (right access operations to the account), which means that this allows the method to be carried with relatively little complexity. Within the context of this invention, a method for accessing an account is understood to mean both a method for debiting a sum value from the account and a method for requesting account balance information.

The method may proceed in a manner such that receipt of the access confirmation message by the access device is followed by erasure of the buffer store. This releases the memory space in the buffer store for further method cycles.

In still another embodiment of the invention, the method may also proceed in a manner such that the access message prompts the account management device to reduce the account balance in the account by the second sum value if the account balance in the account is too small to reduce it by the total sum value which corresponds to the sum value, and in this case to send a modified access confirmation message relating merely to the second sum value to the access device. In the case of this embodiment of the inventive method, it is advantageously possible to carry out the method even when the account balance is small, by virtue of the account balance in the account being reduced only by the second sum value (which corresponds to a small first sum value from a previous method cycle or to the total of a number of small first sum values from a plurality of previous method cycles). The account balance is thus reduced by the second sum value, which is buffer-stored in the buffer store. It is thus advantageously possible to take into account at least the second sum value from previous method cycles if appropriate, even with a small account balance.

The inventive method allows the access message to be transmitted almost in real time using an interface which connects the access device and the account management device. This embodiment permits very fast transmission of the access message.

In yet another embodiment of the invention, the access device, having received a billing message which includes the first sum value, can identify the occurrence of the billing request which relates to the first sum value. In this case, it is advantageously possible to use the billing message to send the access device the information that a billing request has been received; the access device then starts to read the second sum value, which is buffer-stored in the buffer store.

The account used in the case of the inventive method may be a prepaid credit account.

Advantageously, the account management device used in the case of the inventive method may be a service control point in a telecommunication network which has a structure associated with an intelligent network. This allows service control points which already exist in telecommunication networks to be used when implementing the inventive method.

### BRIEF DESCRIPTION OF THE INVENTION

The invention is explained in further detail below with reference to the exemplary embodiments, in which:

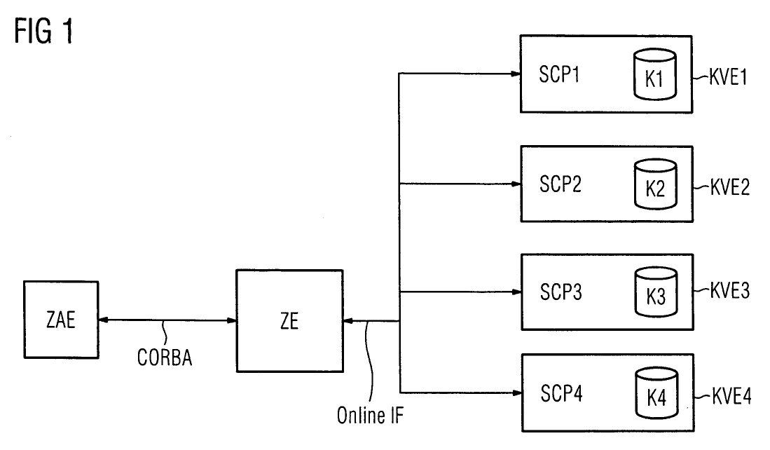

FIG. 1 shows an exemplary embodiment of devices for carrying out the invention.

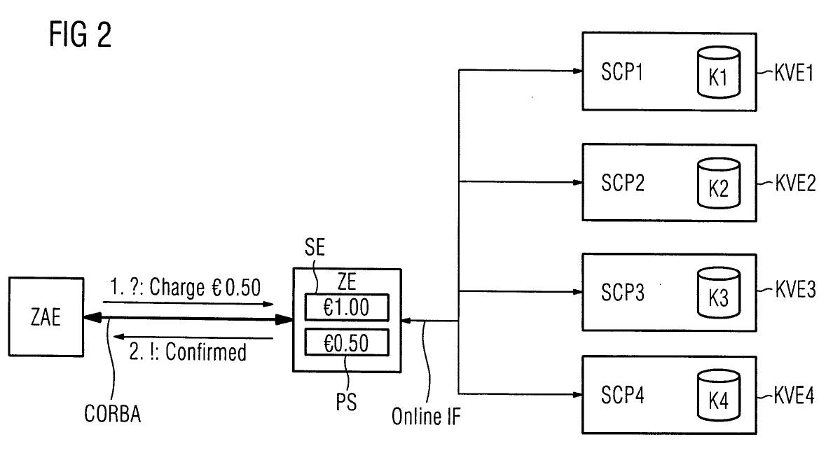

FIG. 2 shows an exemplary embodiment of a method in the invention.

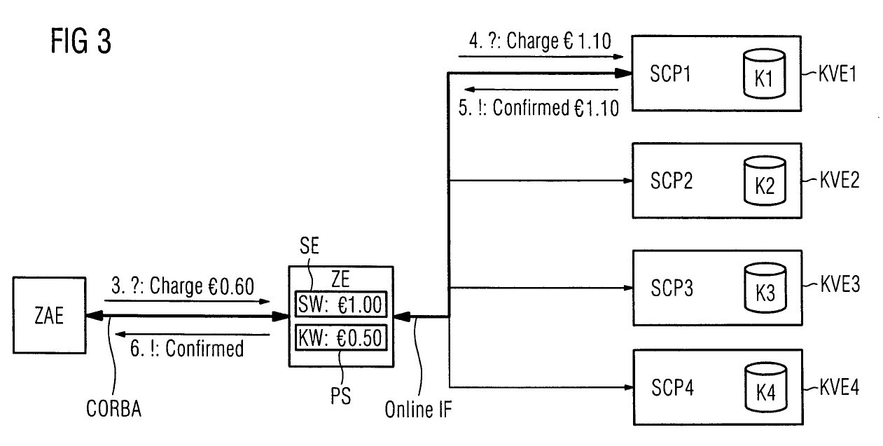

FIG. 3 shows a further exemplary embodiment of a method in the invention.

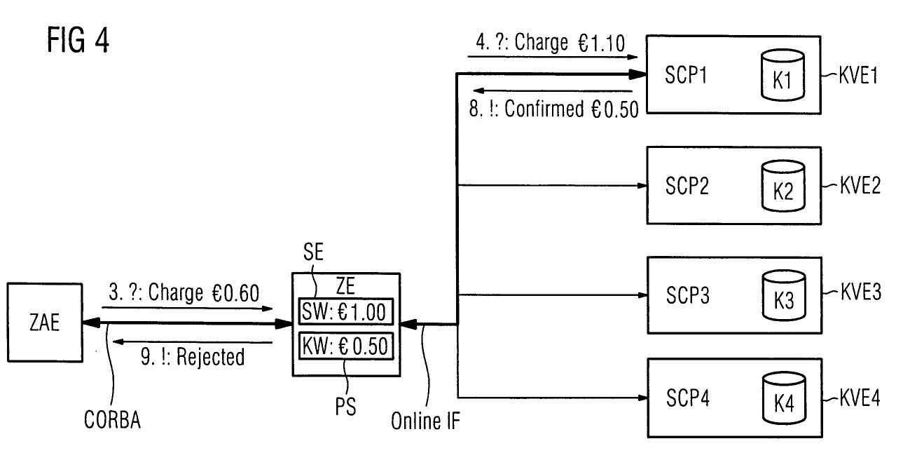

FIG. 4 shows a further exemplary embodiment of a method in the invention.

### DETAILED DESCRIPTION OF THE INVENTION

The right-hand side of FIG. 1 shows an account management device KVE1, which in the exemplary embodiment is a service control point SCP1 in a second generation mobile radio network, this mobile radio network having a structure associated with an intelligent network. The account management device KVE1 manages an account K1 belonging to a mobile radio subscriber using a database which is shown schematically as a cylinder. Similarly, the right-hand side of FIG. 1 shows a second account management device KVE2 with a second account K2, a third account management device KVE3 with a third account K3, and a fourth account management device KVE4 with a fourth account K4. By way of example, the account management devices may be “INXpress V6.2” service control points from Siemens AG. In the exemplary embodiment, the account K1 is a prepaid credit account (prepaid account) belonging to the mobile radio subscriber.

The account management devices KVE1 to KVE4 are connected to an access device ZE via an interface which is referred to as an online interface “Online IF”. An example of an access device ZE of this type is the “charging@advantage” product from Siemens AG. This access device is a charging system which can be used to bill (charge) for the use of telecommunication services by mobile telephones belonging to mobile subscribers (particularly subscribed to “IP services”, which are provided using the IP protocol (Internet protocol)). The access device ZE is connected to a payment request device ZAE via a second interface with online capability (which is provided using inherently known CORBA technology in the exemplary embodiment). This payment request device may be, by way of example, a computer belonging to a trader (third party merchant), which the trader wishes to use to debit one of the accounts or to request information about one of the accounts. The payment request device ZAE, the access device ZE and the account management devices KVE1 to KVE4 may respectively form elements of the mobile radio network (or else of other telecommunication networks) or may alternatively be implemented outside the network and connected to the network.

FIG. 2 shows that the access device ZE includes a buffer store PS and a memory unit SE. The buffer store PS can store sum values and the memory unit SE can store a threshold value. Such sum values and the threshold value correspond to the type of storage of account sums in the accounts K1 to K4. In the exemplary embodiment, the accounts K1 to K4 are managed in the currency unit euro (), and consequently the buffer store PS and the memory unit SE are also used to store sum values or the threshold value with the unit . At the beginning of the method, the buffer store PS stores the value 0 ; the memory unit SE has already been used to store a predetermined threshold value amounting to 1.00 before the start of the method.

The payment request device ZAE sends a billing message 1 (“charge request”), which contains a first sum value “0.50”, to the access device ZE. The billing message 1 contains the information that the account K1 needs to be debited with the sum value amounting to 0.50. The access device ZE receives this billing message 1 and then identifies that there is a billing request relating to the account K1.

The access device ZE then reads the buffer store PS associated with the account K1 for the second sum value, buffer-stored in the buffer store, amounting to 0.00 and adds the first sum value and the second sum value to form a total value. This total value is 0.50 (0.00+0.50=0.50). The access device ZE then compares the total value (0.50) with the predetermined threshold value (1.00) stored in the memory unit SE and ascertains that the total value does not exceed the threshold value, but rather undershoots it (0.50<1.00). The access device ZE then buffer-stores the threshold value amounting to 0.50 in the buffer store PS, which means that the memory unit SE and the buffer store PS now contain the values shown in FIG. 2. The access device ZE then terminates the processing of the current access operation and returns a billing confirmation message 2 (“confirmed”) to the payment request device ZAE. This billing confirmation message 2 is used to send the payment request device ZAE the information that the account K1 includes an account balance at least amounting to the requested 0.50, and hence payment/debiting of the requested first sum value is assured. This billing confirmation message 2 is sent to the payment request device ZAE without the access device ZE actually having accessed the account balance in the account K1 using an access message and hence having checked this account balance. This is not conveyed to the payment request device, however; the payment request device ZAE merely receives from the billing confirmation message 2 the information that the account K1 includes an account balance at a sufficient level.

FIG. 3 shows further method steps which follow the steps explained with reference to FIG. 2 in a further method cycle. The payment request device ZAE (or else a further payment request device (not shown in FIG. 3)) sends a further billing message 3 relating to the account K1, which billing message includes a further first sum value amounting to 0.60, to the billing device ZE. When the further billing message 3 is received, the access unit ZE is informed about the fact that there is further access. The access device ZE then reads the buffer store PS associated with the account K1 for the second sum value (amounting to 0.50) buffer-stored in said buffer store in the previous method cycle, and adds this second sum value to the first sum value. This results in a total value amounting to 1.10 (0.50+0.60=1.10). The access device ZE compares this total value with the threshold value (1.00) and, as the result of this comparison operation, ascertains that the total value exceeds the threshold value. The access device ZE then sends an access message 4 relating to the account K1 to the account management device KVE1. In this case, the access message 4 is transmitted immediately after it has been produced (i.e. in real time) via the “Online IF” interface. The access message 4 contains the total value (1.10) and the information that the account management device needs to check whether the account balance in the account K1 is at least at a level which corresponds to the total value (1.10) and that the account management device needs to reduce the account balance by a total sum value which corresponds to the total value (i.e. by 1.10) if the result of the check is positive. In addition, the access message 4 contains the information that the total value (1.10) is made up of the buffer-stored second sum value amounting to 0.50 and from the first sum value amounting to 0.60.

In the exemplary embodiment, it will be assumed that the account K1 has an account balance amounting to 10. The account management device KVE1 reduces the account balance in the account K1 by 1.10 and returns an access confirmation message 5 (“confirmed 1.10”) to the access device ZE. This access confirmation message (success message) 5 is used to transmit the information that the account balance in the account K1 was able to be reduced by the sum to be billed 1.10 (i.e. that the debit was able to be performed successfully). The sum of money amounting to 1.10 is later transferred outside this method in conventional fashion (for example by means of a bank transfer) to an account which is associated with the payment request device ZAE.

The access device ZE receives this access confirmation message 5, subsequently erases the buffer store PS (so that it returns to the value 0.00), and returns a further billing confirmation message 6 to the payment request device ZAE. This further billing confirmation message 6 is used to send the payment request device ZAE the information that the sum value amounting to 0.60 was able to be debited from the account K1. The payment request device ZAE is not sent the information that it was even possible to debit 1.10 from the account, however.

FIG. 4 shows a further method cycle for the inventive method, which differs from the method cycle described with reference to FIG. 3 in that the account K1 contains just a prepaid credit amounting to 0.80. Following receipt of the access message 4, the account management device KVE1 reduces the account balance in the account K1 just by the second sum value (0.50) and returns a further access confirmation message 8 about just 0.50 to the access device ZE. The access device ZE then erases the buffer store PS, so that it includes the value 0.00. The access device ZE then terminates processing of the access operation and sends a billing rejection message 9 (“rejected”) to the payment request device ZAE. This is used to send the payment request device ZAE the information that the account balance in the account K1 was not adequate to debit the sum value amounting to 0.60 from this account, i.e. to reduce the account balance by this sum value.

In a further alternative embodiment, the inventive method may proceed in such a manner that the access message prompts the account management device merely to check whether the account balance in the account is at least at a value which corresponds to the total value. If this is the case, this information is sent to the access device using a modified access confirmation message.

The inventive method affords the advantage that very small first sum values (that is to say extremely small sums which are to be debited from the account K1, for example) do not result in the sending of access messages to the account management device KVE1 (and hence in a large number of debit operations for extremely small sums), but rather that these very small first sum values continue to be added until the total exceeds the threshold value.

The inventive method has the particular advantage that the Online-Interface (Online IF) interface can be designed for a lower data rate (access messages per hour or access confirmation messages per hour) than the second interface CORBA. By way of example, it may be sufficient for the Online-Interface interface to transmit a maximum of 200 000 access messages per hour to the account management device KVE1, whereas the second interface CORBA can transmit a maximum of one million billing messages to the access device ZE. The inventive method thus significantly reduces the load on the Online-Interface interface. Similarly, the account management device KVE1 is advantageously relieved of load, since it also needs to process only a maximum of 200 000 access messages per hour. This relieves the load on the technically complex and expensive online resources (Online IF interface and account management device KVE1), which means that these can either be implemented with comparatively low power (and hence inexpensively) or can be used for other tasks in parallel.

It is particularly advantageous that account management devices and interfaces which have already been installed can continue to be used without expensive (and in many cases difficult or impossible in practice) upgrades even when there is an increasing number of billing messages per unit time by choosing an appropriately high threshold value.

1. A method for accessing an account in an account management device, when a billing request arises which relates to a first sum value in the account, comprising:
reading a second sum value, which is buffer-stored in a buffer store associated with the account, from the buffer store;
adding the first sum value and the second sum value to form a total value; and
comparing the total value with a predetermined threshold value, wherein
an access message relating to the account is sent to the account management device if the threshold value is exceeded, and
the total value is buffer-stored in the buffer store and the access is terminated if the threshold value is undershot.

2. The method as claimed in claim 1, wherein
the access message prompts the account management device to reduce the account balance in the account by a total sum value which corresponds to the total value and, upon successful reduction, to send an access confirmation message to the access device.

3. The method as claimed in claim 2, wherein
receipt of the access confirmation message by the access device is followed by erasure of the buffer store.

4. The method as claimed in claim 1, wherein
the access message prompts the account management device to reduce the account balance in the account by the second sum value if the account balance in the account is too small to reduce it by the total sum value which corresponds to the sum value, and sends a modified access confirmation message relating merely to the second sum value to the access device.

5. The method as claimed in claim 1, wherein
the access message is transmitted substantially in real time using an interface which connects the access device and the account management device.

6. The method as claimed in wherein
the access device, having received a billing message which includes the first sum value, identifies the occurrence of the billing request which relates to the first sum value.

7. The method as claimed in claim 1, wherein
the account used is a prepaid credit account.

8. The method as claimed in wherein
the account management device used is a service control point in a telecommunication network which has a structure associated with an intelligent network.
